(19) United States
(12) Patent Application Publication
(10) Pub. No.: US 2025/0367822 A1
(43) Pub. Date: Dec. 4, 2025

(54) ROBOT CONTROL DEVICE AND ROBOT CONTROL SYSTEM

(71) Applicant: FANUC CORPORATION, Yamanashi (JP)

(72) Inventor: Mikito HANE, Yamanashi (JP)

(21) Appl. No.: 18/875,167

(22) PCT Filed: Jun. 30, 2022
(86) PCT No.: PCT/JP2022/026382

§ 371 Date: Dec. 16, 2024

(51) Int. Cl. B25J 9/16

(52) U.S. Cl. CPC B25J 9/163

(57) ABSTRACT

A robot control device according to one aspect of the present disclosure is a computer device that controls a robot provided with a sensor. The robot control device includes a storage unit configured to store a parameter for setting an operation of a robot in association with an index value representing an operation state of the robot that operates in accordance with the parameter, a search unit configured to search for the parameter based on the index value, and a display unit configured to display the searched parameter.

### RELATED APPLICATIONS

The present application is a National Phase of International Application No. PCT/JP2022/026382 filed Jun. 30, 2022.

### TECHNICAL FIELD

The present invention relates to a robot control device and a robot control system for controlling a robot.

### BACKGROUND ART

Robot teaching is an essential task to cause the robot to perform a predetermined operation. With the spread of robots, not only highly skilled operators but also less-skilled operators have to perform robot teaching. On the other hand, as robots become more sophisticated, robot teaching becomes more complicated. For this reason, a robot teaching assistance device having a function of assisting the operator in robot teaching has been proposed (Patent Literature 1).

In particular, it is not a simple task for low-skilled operators who do not have a good understanding of operation parameters to correct the operation parameters to appropriate values to prevent abnormal situations from occurring, because they do not know which operation parameter affected the abnormal situation when an abnormal situation occurs, such as when an alarm is generated during operation of the robot, when operation of the robot is stopped in the middle, or the like. For example, when abnormal situations occurred, operators used manuals to find out how to solve the abnormal situation. However, since manuals contain a lot of information, the task of finding out the solution using manuals is time-consuming and reduces the overall efficiency of robot teaching.

### CITATION LIST

### Patent Literature

Patent Literature 1: Japanese Unexamined Patent Application Publication No. 2014-233814

### SUMMARY

### Problem to be Solved

Although it is inefficient, operators can gradually accumulate know-how by repeatedly performing operation parameter setting while referring to manuals. This know-how is important information because it was obtained through time and effort. With the know-how, even less-skilled operators can smoothly perform parameter setting. Accordingly, when the operator in charge of robot teaching is changed, it is very important to transfer the know-how accumulated by the operator in charge to the new operator. However, the know-how includes those corresponding to various cases, and transferring all of the know-how to the new operator was not easy and required a great deal of time. Therefore, it is desired to efficiently utilize the know-how of predecessors in robot teaching.

### Solution to Problem

A robot control device according to one aspect of the present disclosure is a computer device that controls a robot provided with a sensor. The robot control device includes a storage unit configured to store a parameter for setting an operation of the robot in association with an index value representing an operation state of the robot that operates in accordance with the parameter, a search unit configured to search for the parameter based on the index value, and a display unit configured to display the searched parameter.

### BRIEF DESCRIPTION OF THE DRAWINGS

FIG. 1 is a perspective view showing a robot apparatus including a robot control device according to the present embodiment.

FIG. 2 is a functional block diagram of the robot control device according to the present embodiment.

FIG. 3 shows an example of a formula stored in a storage unit shown in FIG. 2.

FIG. 4 shows an example of a setting history management table stored in the storage unit shown in FIG. 2.

FIG. 5 shows an example of an assignment table relating to an operation abnormality stored in the storage unit shown in FIG. 2.

FIG. 6 shows an example of an assignment table relating to the success or failure of operation stored in the storage unit shown in FIG. 2.

FIG. 7 shows an example of a weighting coefficient management table stored in the storage unit shown in FIG. 2.

FIG. 8 shows an example of a search screen displayed on a display unit shown in FIG. 2.

FIG. 9 shows an example of a simulation screen displayed on the display unit shown in FIG. 2.

### DETAILED DESCRIPTION

Hereinafter, a robot control device according to the present embodiment will be described with reference to the drawings. In the following description, constituent elements having substantially the same function and configuration are denoted by the same reference numeral, and repetitive descriptions will be given only where necessary.

A robot control device according to the present embodiment is a computer device having a function of storing an operation parameter for setting an operation of a robot in association with an index value representing an operation state of the robot (hereinafter, sometimes simply referred to as an index value), a function of searching for the operation parameter based on the index value, and a function of displaying the searched operation parameter.

The “index value representing an operation state of the robot” is a numerical value representing the state of the robot in operation or the operation result of the robot in accordance with a predetermined rule. Typically, the index value representing the operation state of the robot is derived based on the cycle time of the robot, the torque value applied to the robot in operation, the presence or absence of the overheat alarm, and the degree of success or failure of the operation of the robot. As described above, the index value representing the operation state of the robot is not derived only from quantitative data obtained as numerical values such as a cycle time and a torque value, but is derived comprehensively from data also including qualitative data such as the presence or absence of the overheat alarm and the success or failure of the operation.

In the present embodiment, the operation speed, which is the setting information of the moving speed of the hand reference point, is adopted as an example of the operation parameter; however, the operation parameter is not limited to this. For example, for a robot that operates in accordance with the same operation program, various parameters that cause changes in the operation can be adopted as the operation parameter. More specifically, a standby time, an interpolation format, a movement format, or the like can be adopted as the operation parameter. The standby time is the time to stand still when a standby command is described in the operation program. The interpolation format is a condition relating to the interpolation format between two teaching points. For example, the interpolation format includes circular interpolation, linear interpolation, and the like. The movement format is a condition relating to how to move the robot between a plurality of teaching points. For example, the movement format includes a format in which the robot is moved so as to always pass through the teaching points, a format in which the robot does not necessarily have to pass through the teaching points, but is moved smoothly so as to pass through or near the teaching points, and the like.

In the present embodiment, four types of data, that is, the cycle time, the torque value, the presence or absence of the overheat alarm, and the degree of success or failure of the operation, are adopted as the data used to calculate the index value. However, the data used to calculate the index value is not limited to the four types of data described above. For example, the index value can be calculated using at least one type of data among the four types of data. In the present embodiment, the torque value based on the output of the force sensor is adopted as the sensor data used to calculate the index value, but the sensor data is not limited to this. For example, any value based on the output of any sensor mounted on the robot, such as an acceleration based on the output of an acceleration sensor mounted on the robot or a speed based on the output of a speed sensor mounted on the robot, can be used to calculate the index value.

In the present embodiment, overheating is adopted as an example of the operation abnormality used to calculate the index value, but the type of operation abnormality is not limited to this. For example, sudden acceleration, excessive speed, vibration, and the like can be adopted as the operation abnormality. Further, the number of operation abnormalities is not limited to one, and a plurality of operation abnormalities may be used.

In the present embodiment, the degree of success or failure of the operation is of two types, “the operation was successful” and “the operation was not successful”, but the degree is not limited to these. For example, “the operation was successful” may be divided into “the operation was successful and stable” and “the operation was successful but unstable”. Further, “the operation was not successful” may be divided into “the operation is likely to be successful if the operation of the robot is slightly improved” and “the operation will not be successful unless the operation of the robot is greatly improved”. Further, the degree of success or failure of the operation may be divided into five levels, with “5” for the state of complete success and “1” for the state of complete failure. Typically, the degree of success or failure of the operation is input to the robot control device by a user operation. Of course, if the degree of success or failure of the operation is of two types, “the operation was successful” and “the operation was not successful”, it can also be identified based on the outputs of various sensors mounted on the robot.

Hereinafter, a robot control device 1 according to the present embodiment will be described.

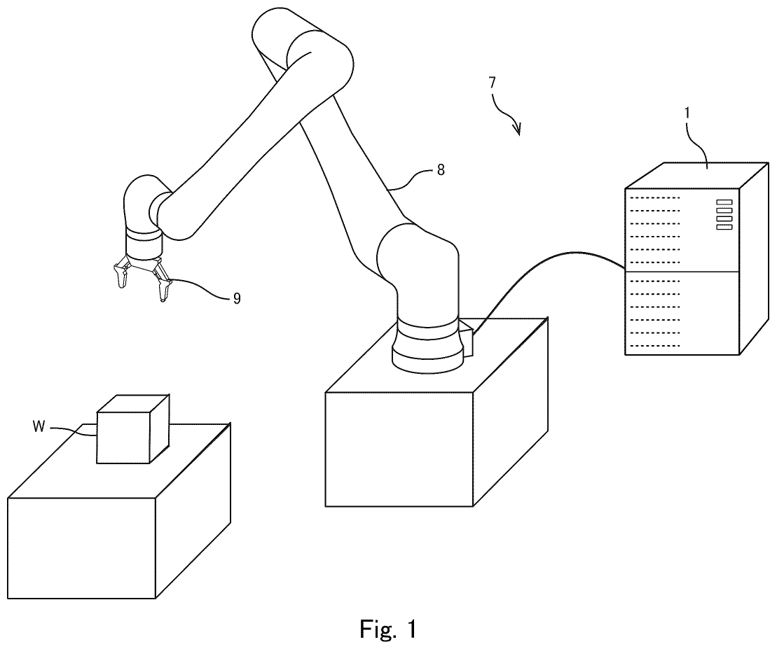

As shown in FIG. 1, the robot control device 1 according to the present embodiment constitutes a robot apparatus 7 together with a robot 8. The robot 8 includes a force sensor 9 for detecting a load applied to an end effector. The output data of the force sensor 9 mounted on the robot 8 is input to the robot control device 1. The sensor 9 mounted on the robot 8 is not limited to the force sensor 9. For example, the robot 8 may include a vision camera for capturing the image of the workpiece W, an encoder that detects the rotational position of the motor, an infrared sensor that detects the presence or absence of an operator or an obstacle, a contact sensor that detects the presence or absence of contact of an operator, and the like.

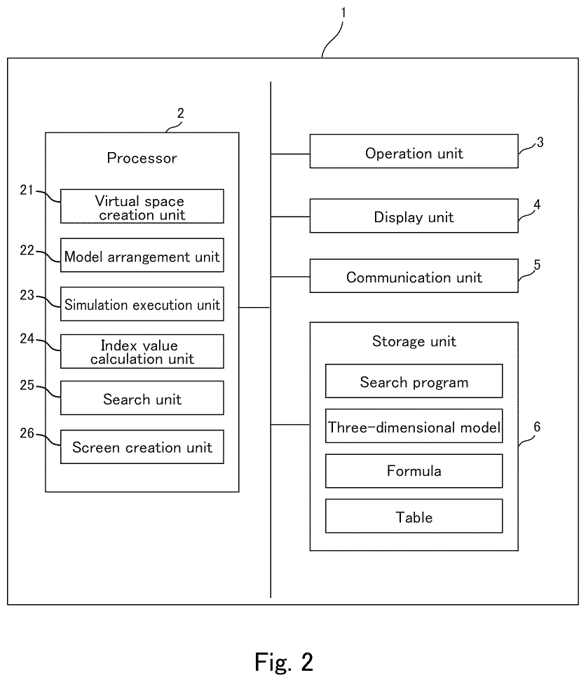

As shown in FIG. 2, the robot control device 1 according to the present embodiment is configured by connecting hardware such as an operation unit 3, a display unit 4, a communication unit 5, and a storage unit 6 to a processor 2 (such as a CPU). The robot control device 1 is provided by a general information processing terminal such as a personal computer or a tablet.

The operation unit 3 includes an input device such as a keyboard, a mouse, or a jog. The input device may be provided by a touch panel that also serves as the display unit 4, or may be provided by a dedicated operation device (pendant) of the robot control device 1. The user can input various types of information into the robot control device 1 through the operation unit 3.

The display unit 4 has a display device such as an LCD, and displays a search screen 100, a simulation screen 200, and the like created by a screen creation unit 26. The communication unit 5 controls transmission and reception of data to and from the robot 8. Through the processing of the communication unit 5, the robot control device 1 receives output data from the force sensor 9 mounted on the robot 8.

The storage unit 6 includes a storage device such as an HDD or an SSD. The storage unit 6 stores a search program for searching for an operation parameter, data of three-dimensional models displayed on the simulation screen 200, data of a plurality of types of formulas, and data of a plurality of types of tables.

The data of three-dimensional models include data of a three-dimensional model of the robot 8, which includes the force sensor 9, and data of a three-dimensional model of the workpiece. Typically, the data of three-dimensional models are provided by CAD data.

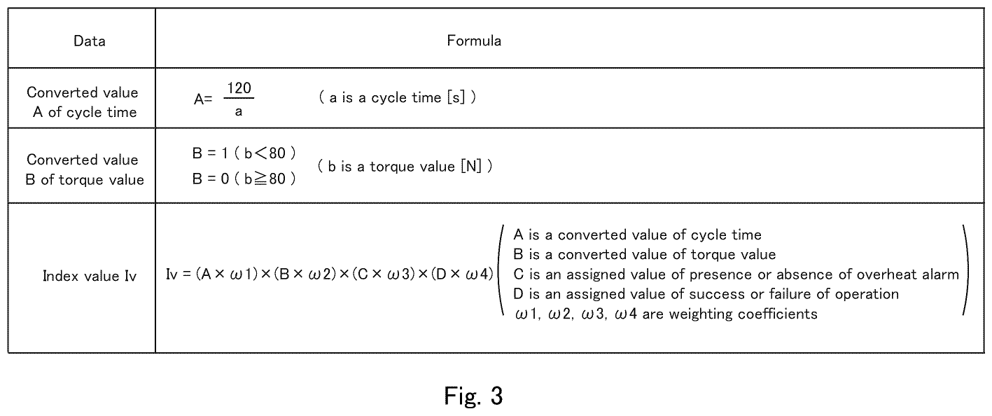

The formulas include a cycle time conversion formula, a torque value conversion formula, an index value calculation formula, and the like. The cycle time conversion formula is a calculation formula for converting a cycle time into a value for calculating the index value. As shown in FIG. 3, the converted value A of a cycle time can be obtained by substituting the cycle time into the variable a of a conversion formula “A=120/a”. The conversion formula of the converted value B of a torque value is given by “B=1 (b<80), B=0 (b≥80)”. That is, the torque value is binarized, and if the value b is 80 or more, the torque value is converted into a numerical value “0”, and if the value b is less than 80, the torque value is converted into a numerical value “1”. The index value Iv can be obtained by substituting numerical values into the variables A, B, C, D, and ω1 to ω4 of a calculation formula

$$“ lv = ( A \times ω1 ) \times ( B \times ω2 ) \times ( C \times ω3 ) \times ( D \times ω4 ) ” .$$

The plurality of types of tables include a setting history management table for managing operation speeds set in the past, an assignment table for assigning a numerical value to the presence or absence of the overheat alarm (to be referred to as an assignment table relating to the operation abnormality), an assignment table for assigning a numerical value to the degree of success or failure of the operation (to be referred to as an assignment table relating to the success or failure of the operation), and a weighting coefficient management table for managing weighting coefficients used to calculate the index value.

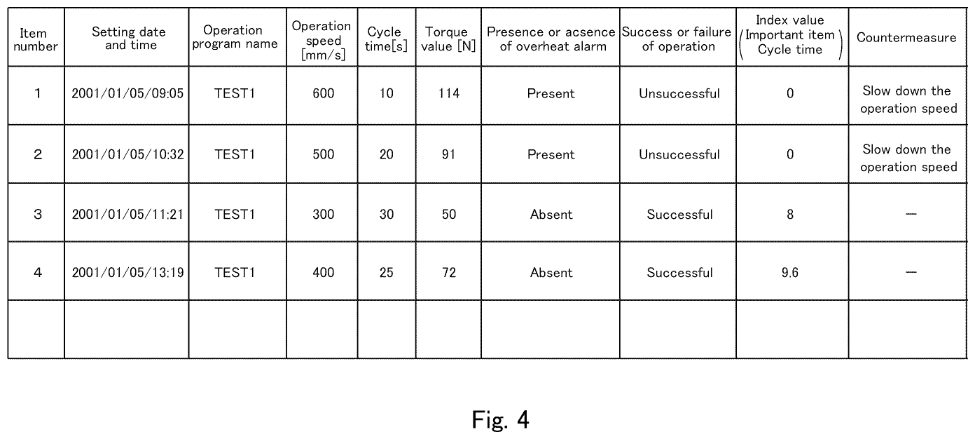

FIG. 4 shows an example of the setting history management table.

As shown in FIG. 4, one record in the setting history management table manages an item number, a setting date and time, an operation program name, an operation speed, a cycle time, a torque value, the presence or absence of the overheat alarm, the success or failure of the operation, an index value, and a countermeasure. One record of the setting history management table will be referred to as a setting history record. For example, of the setting history record, the operation program name, the operation speed, and the countermeasure are registered based on user input information. The cycle time, the torque value, the presence or absence of the overheat alarm, the success or failure of the operation, and the index value are automatically registered by internal processing of the robot control device 1. Of course, the cycle time, the torque value, the presence or absence of the overheat alarm, the success or failure of the operation, and the index value may be partially input by the user.

The operation speed is an example of the operation parameter, and is a parameter for setting the moving speed of the hand reference point. The cycle time corresponds to the time actually taken from the operation start to the operation end when the robot 8 executes a series of operations defined by the operation program. The torque value corresponds to the maximum value of the torque value applied to the robot 8 in operation, which is calculated based on the output of the force sensor 9 mounted on the robot 8. The overheat alarm is issued when the motor is driven at high RPM, when the motor is driven in a severe cycle, or when the actual temperature of the motor or its surroundings is high. The success or failure of the operation indicates whether or not the robot 8 was able to normally perform the series of operations defined by the operation program. Here, “normal” indicates that the series of operations defined by the operation program can be performed within a specified time. For example, there is a case where the robot 8 is temporarily stopped during operation, and the series of operations defined by the operation program cannot be completed within a specified time. There is a case where an operation defined by the operation program fails. In these cases, the success or failure of the operation is “unsuccessful”.

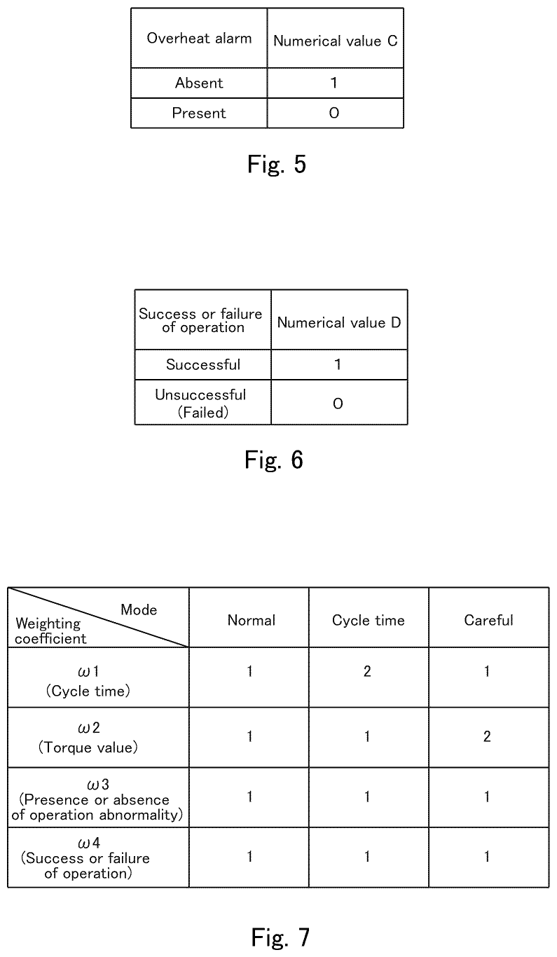

FIG. 5 shows an example of the assignment table relating to the operation abnormality.

As shown in FIG. 5, in the assignment table relating to the operation abnormality, a numerical value is assigned to each of the presence and absence of the overheat alarm. A numerical value C “1” is assigned to the “absent” of the overheat alarm, and a numerical value C “0” is assigned to the “present” of the overheat alarm. Although the assignment values are initially determined as described above, the assignment values can be appropriately changed in accordance with a user operation.

In the present embodiment, overheating is adopted as the operation abnormality, and a numerical value is assigned to each of the presence and absence thereof. However, the degree of overheating may be divided into three or more levels, and a numerical value may be assigned to each level. Further, a plurality of types of operation abnormalities may be included. The operation abnormality includes a major operation abnormality that affects the success or failure of the operation and a minor operation abnormality that does not affect the success or failure of the operation. Therefore, the numerical value assigned may be different depending on the type of operation abnormality.

FIG. 6 shows an example of an assignment table relating to the success or failure of the operation.

As shown in FIG. 6, in the assignment table relating to the success or failure of the operation, a numerical value is assigned to each of the success and failure of the operation. A numerical value D “1” is assigned to the “successful” of the operation, and a numerical value D “0” is assigned to the “unsuccessful (failure)” of the operation. Although the assignment values are initially determined as described above, the assignment values can be appropriately changed in accordance with a user operation.

In the present embodiment, “successful” and “unsuccessful” are adopted as the degree of success or failure of the operation, and a numerical value is assigned to each of them. However, as described above, the degree of success or failure of the operation may be divided into three or more levels, and a numerical value may be assigned to each level.

FIG. 7 shows an example of the weighting coefficient management table. The weighting coefficient is a parameter for changing the degree of influence of the cycle time, the torque value, the presence or absence of the overheat alarm, and the success or failure of the operation on the index value.

For example, when the user considers the cycle time important for the operation of the robot, the weighting coefficient corresponding to the cycle time is set to be greater than the other weighting coefficients. As shown in FIG. 6, the weighting coefficient ω1 corresponding to the cycle time is set to “2”, the weighting coefficient ω2 corresponding to the torque value is set to “1”, the weighting coefficient ω3 corresponding to the presence or absence of the operation abnormality is set to “1”, and the weighting coefficient ω4 corresponding to the success or failure of the operation is set to “1”.

For example, when the user considers careful movements important for the operation of the robot, the weighting coefficient corresponding to the torque value is set to be greater than the other weighting coefficients. As shown in FIG. 6, the weighting coefficient ω1 corresponding to the cycle time is set to “1”, the weighting coefficient ω2 corresponding to the torque value is set to “2”, the weighting coefficient ω3 corresponding to the presence or absence of the operation abnormality is set to “1”, and the weighting coefficient ω4 corresponding to the success or failure of the operation is set to “1”.

As shown in FIG. 2, when the search program stored in the storage unit 6 is executed by the processor 2, the robot control device 1 functions as a virtual space creation unit 21, a model arrangement unit 22, a simulation execution unit 23, an index value calculation unit 24, a search unit 25, and a screen creation unit 26.

The virtual space creation unit 21 creates a virtual space on software that three-dimensionally represents an operation space in which the robot operates. The virtual space created by the virtual space creation unit 21 is displayed on the simulation screen 200 created by the screen creation unit 26.

The model arrangement unit 22 arranges a three-dimensional model 8′ of the robot 8 (robot model 8′) and a three-dimensional model W′ of the workpiece W (workpiece model W′) in the virtual space created by the virtual space creation unit 21 and displayed on the simulation screen 200. The robot model 8′ and the workpiece model W′ are arranged in the virtual space so as to correspond to the positional relationship between the robot 8 and the workpiece W in the actual operation space.

The simulation execution unit 23 executes a simulation operation for operating, in simulation, the robot model 8′ in the virtual space displayed on the simulation screen 200 in accordance with the operation program and the operation speed or in accordance with a user instruction through the operation unit 3. By the processing of the simulation execution unit 23, the robot model 8′ displayed on the simulation screen 200 can be operated in accordance with the operation speed selected by the user. Accordingly, based on the operation speed associated with the fact that the operation was not successful, the operation of the robot 8 when the operation was not successful can be reproduced on the simulation screen 200 and displayed as a moving image. In addition, the setting history record is associated with a point in time during operation when an event that is a cause of the unsuccessful operation occurred and whether an overheat alarm was issued. On the simulation screen 200, the user can confirm the event that is a cause of the unsuccessful operation through the position and posture of the robot 8 at that time, and correct the operation of the robot 8 so that the operation will be successful.

The index value calculation unit 24 calculates an index value representing the operation state of the robot. Typically, the index value calculation unit 24 converts the cycle time a into a converted value A using the conversion formula of the cycle time shown in FIG. 3, and converts the torque value b into a conversion value B using the conversion formula of the torque value. In addition, referring to the assignment table shown in FIG. 5, a numerical value C is assigned to the presence or absence of the overheat alarm. Referring to the assignment table shown in FIG. 6, a numerical value D is assigned to the success or failure of the operation. In addition, referring to FIG. 7, the weighting coefficients ω1, ω2, ω3, and ω4 are identified based on the important item input by the user. Then, the index value calculation unit 24 calculates the index value Iv by substituting the conversion value A, the conversion value B, the assignment value C, the assignment value D, and the weighting coefficients ω1, ω2, ω3, and ω4 into the calculation formula of the index value Iv shown in FIG. 3. Needless to say, the method of calculating the index value is not limited to these.

The search unit 25 searches the setting history management table in accordance with a search condition input by a user operation on the search screen 100, and extracts an operation speed. Typically, the search unit 25 searches the setting history management table and extracts an operation speed associated with the largest index value as a recommended operation speed.

However, the method of searching for the operation speed by the search unit 25 is not limited to this. For example, the search unit 25 may search the setting history management table and extract a plurality of operation speeds in descending order of index values as operation speeds to be presented. Further, an operation speed having a value close to the recommended operation speed and associated with the “present” of the overheat alarm may be extracted as a reference operation speed.

The screen creation unit 26 creates a search screen 100 for the user to search for an operation speed and a simulation screen 200 for reproducing the operation of the robot based on the operation speed selected by the user.

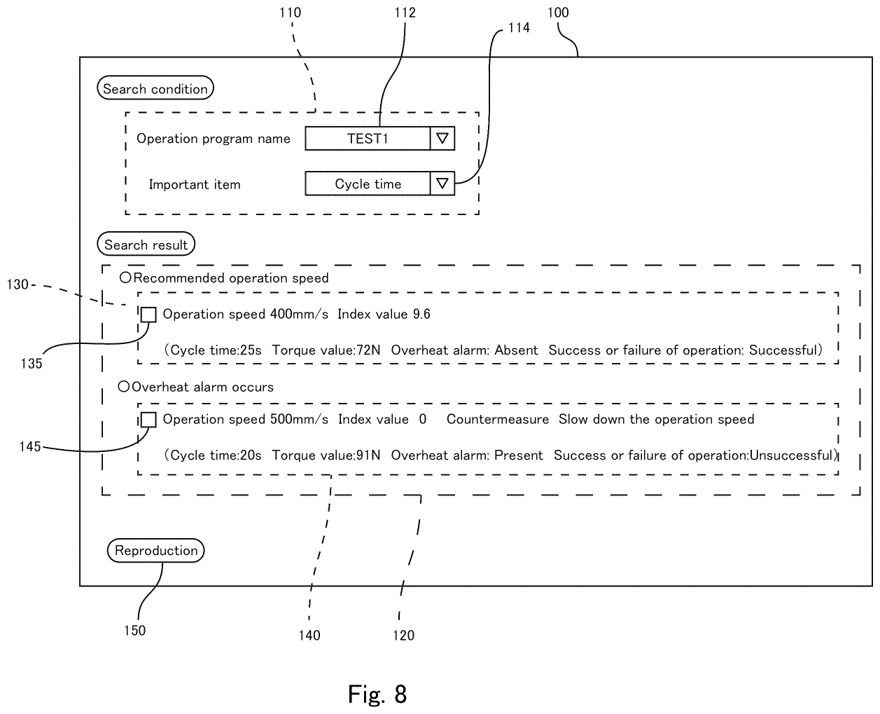

The search screen 100 created by the screen creation unit 26 will be described below with reference to FIG. 8. As shown in FIG. 8, the search screen 100 includes a search condition display area 110 where search conditions are displayed, a search result display area 120 where search results are displayed, and a reproduction button 150 for transition from the search screen 100 to the simulation screen 200.

In the search condition display area 110, a pull-down menu 112 is arranged in association with the search condition “operation program name”, and a pull-down menu 114 is arranged in association with the search condition “important item (level of importance)”.

The search result display area 120 includes an area 130 for displaying the recommended operation speed and an area 140 for displaying the operation speed associated with the “present” of the overheat alarm. The area 130 displays a recommended operation speed for the search condition input by the user as well as an index value associated with the operation speed, a cycle time, a torque value, the presence or absence of the overheat alarm, and the success or failure of the operation. The area 140 displays an operation speed of the setting history record associated with the “present” of the overheat alarm as well as an index value, a cycle time, a torque value, the success or failure of the operation, and the countermeasure taken to prevent overheating. Check boxes 135 and 145 for receiving an operation of selecting an operation speed are arranged in the respective areas 130 and 140.

As shown in FIG. 8, when an operation program name “TEST1” and an important item “cycle time” are input by a user operation on the search screen, the robot control device 1 refers to the setting history management table through the processing of the index value calculation unit 24 to extract a setting history record associated with the operation program name “TEST1” and calculates an index value of the extracted setting history record.

Specifically, the robot control device 1 refers to the weighting coefficient management table shown in FIG. 7 and determines the weighting coefficients corresponding to the important item “cycle time” to be ω1=2, ω2=1, ω3=1, and ω=1.

The robot control device 1 converts the cycle time a using the conversion formula of the cycle time shown in FIG. 3, and converts the torque value b using the conversion formula of the torque value. For example, the cycle time “10 s” of the item number “1” is converted into the numerical value A “12”, the cycle time “20 s” of the item number “2” is converted into the numerical value A “6”, the cycle time “30 s” of the item number “3” is converted into the numerical value A “4”, and the cycle time “25 s” of the item number “4” is converted into the numerical value A “4.8”.

The robot control device 1 refers to the assignment table relating to the operation abnormality shown in FIG. 5 to assign a numerical value C to the presence or absence of the overheat alarm. For example, the numerical value C “0” is assigned to the “present” of the overheat alarm in the item numbers “1” and “2”, and the numerical value C “1” is assigned to the “absent” of the overheat alarm in the item numbers “3” and “4”.

The robot control device 1 refers to the assignment table relating to the success or failure of the operation shown in FIG. 6 to assign a numerical value D to the success or failure of the operation. For example, the numerical value “0” is assigned to the “unsuccessful” of the success or failure of the operation of the item numbers “1” and “2”, and the numerical value “1” is assigned to the “successful” of the success or failure of the operation of the item numbers “3” and “4”.

The robot control device 1 calculates the index value Iv corresponding to the setting history record by substituting the numerical values A, B, C, and D and the weighting coefficients ω1, ω2, ω3, and ω4 into the calculation formula of the index value Iv shown in FIG. 3. As shown in FIG. 4, the index value “0” corresponding to the item number “1”, the index value “0” corresponding to the item number “2”, the index value “8” corresponding to the item number “3”, and the index value “9.6” corresponding to the item number “4” are calculated.

The robot control device 1 extracts the item number “4” having the largest index value through the processing of the search unit 25 to identify the operation speed “400 mm/s” associated with the item number “4” as the recommended operation speed. Accordingly, as shown in FIG. 8, together with the recommended operation speed “400 mm/s”, the index value “9.6” associated with the operation speed “400 mm/s”, the cycle time “25 s”, the torque value “72 N”, the “absent” of the overheat alarm, and the “successful” of the success or failure of the operation are displayed.

The robot control device 1 extracts the item number “2” having the cycle time “500 mm/s” which is closer to the cycle time “25 s” of the recommended operation speed “400 mm/s” from the item numbers “1” and “2” associated with the “present” of the overheat alarm through the processing of the search unit 25. Then, the operating speed “500 mm/s” associated with the item number “2” is identified as the operation speed associated with the “present” of the overheat alarm. Accordingly, as shown in FIG. 8, the index value “0”, the cycle time “20 s”, the torque value “91 N”, the “present” of the overheat alarm, and the “unsuccessful” of the success or failure of the operation are displayed together with the operation speed “500 mm/s” as the setting history record associated with the “present” of the overheat alarm.

However, the configuration of the search screen 100 is not limited to the present embodiment.

In the present embodiment, the index value associated with an operation speed, the torque value, the presence or absence of the overheat alarm, and the success or failure of the operation are displayed together with the operation speed.

In the present embodiment, in order to assist the user in setting the operation speed, the operation speed associated with the “present” of the overheat alarm is displayed together with the recommended operation speed, but the user only needs to know at least the recommended operation speed, and only the recommended operation speed may be displayed.

Although only one recommended operation speed is displayed in the present embodiment, a plurality of operation speeds may be displayed in order of recommendation. Further, not one but a plurality of operation speeds associated with the “present” of the overheat alarm may be displayed. Further, the operation speed associated with the “unsuccessful” of the success or failure of the operation may be displayed.

In the present embodiment, a search item is selected from the pull-down menu, but a search field may be provided and the user may freely input a search condition into the search field.

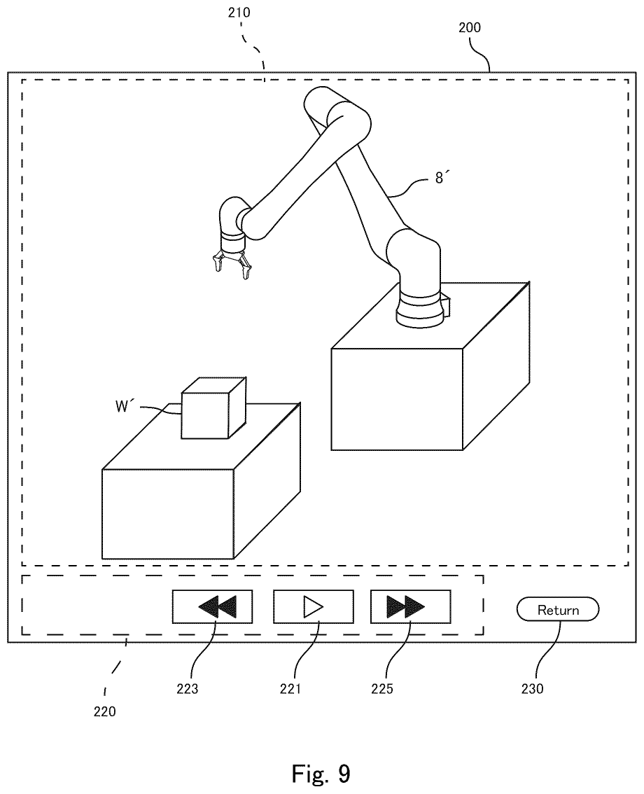

The simulation screen 200 created by the screen creation unit 26 will be described below with reference to FIG. 9. The simulation screen 200 is displayed when an operation speed is selected by a user operation on a check box 135, 145 displayed on the search screen 100 shown in FIG. 8 and the reproduction button 150 is clicked. As shown in FIG. 9, the simulation screen 200 includes a moving image display area 210 in which a simulation moving image is displayed, an operation area 220 in which a play/pause button 221, a rewind button 223, and a fast-forward button 225 for operating the simulation moving image are displayed, and a return button 230 for returning to the search screen 100. The moving image display area 210 displays a virtual space created by the virtual space creation unit 21, in which the robot model 8′ and the workpiece model W′ are arranged by the model arrangement unit 22. The robot model 8′ is moved by the processing of the simulation execution unit 23. By selecting the check box 145 corresponding to the operation speed associated with the “present” of the overheat alarm on the search screen 100, the user can confirm, by simulation, the operation of the robot 8 when the overheat alarm is generated.

The robot control device 1 according to the present embodiment has the following effects. One feature of the robot control device 1 according to the present embodiment is that the operation speed of the operation program is stored in association with an index value representing the operation state of the robot which operates in accordance with the operation speed. The index value representing the operation state of the robot is a numerical value representing the state of the robot in operation and the operation result of the robot in accordance with a predetermined rule. The predetermined rule includes whether the cycle time is considered important or the careful operation is considered important.

For example, the robot control device 1 can calculate an index value with the degree of influence of the cycle time made large. Accordingly, the robot control device 1 can present the operation speed with the highest calculated index value, i.e., the operation speed of the setting history record that prioritizes the cycle time, as the recommended operation speed to the user who considers the cycle time important. Similarly, the robot control device 1 can calculate an index value with the degree of influence of the torque value made large. Accordingly, the robot control device 1 can present the operation speed with the highest calculated index value, i.e., the operation speed of the setting history record that prioritizes the torque value, as the recommended operation speed to the user who considers the careful operation important.

By associating, with an operation speed, an index value representing the operation state of the robot 8 that operates in accordance with the operation speed, the robot control device 1 can search for the operation speed according to the item desired by the user based on the index value. Accordingly, even if an enormous amount of setting history is held, the operation speed desired by the user can be easily extracted by search, and the time required to find the desired setting history record from the past setting history records can be shortened. Therefore, the robot control device 1 can hold, as know-how, the operation speed when the operation of the robot 8 failed, such as when the cycle time was too slow, the load applied to the robot 8 was too large, an operation abnormality occurred, or the operation was not successful, which is generally deleted, together with the operation speed set to an appropriate value. As described above, holding the operation speed when the operation of the robot 8 failed is also one of the important features of the robot control device 1 according to the present embodiment.

With this feature, the robot control device 1 can present not only the operation speed set to an appropriate value to the user but also the operation speed set to an inappropriate value when the operation of the robot 8 failed. For example, if the information presented from the robot control device 1 is only the recommended operation speed, it is difficult for the user to change the operation speed. This is because, although the user may know the recommended operating speed, the user cannot know how much faster the operation speed can be. In such a case, the user needs to operate the robot 8 on a trial basis while changing the operation speed to grasp how much faster the operation speed can be.

On the other hand, by displaying not only the recommended operation speed but also the operation speed at which the robot 8 failed as a reference operation speed, along with the cause of the failure and how to deal with the failure, as in the present embodiment, the user can grasp how much the operation speed can be increased before the operation fails and what to do in case of a failure. Accordingly, the user can examine the currently set operation speed in detail by referring not only to the recommended operation speed set in the past but also to the operation speed set in the past when the operation of the robot 8 failed so as to make a determination.

As described above, according to the robot control device 1 of the present embodiment, the operator can grasp, as know-how, an operation parameter that has been tried in the past, the cycle time, the torque value, the presence or absence of the operation abnormality, and the success or failure of the operation of the robot 8 that operates in accordance with the operation parameter. Accordingly, it is not necessary to test run the robot 8 with the same operation parameter, and teaching can be efficiently performed.

The robot control device 1 according to the present embodiment calculates one index value representing the robot operation state as an operation result after the robot 8 operates in accordance with an operation program. However, the robot control device 1 may calculate a plurality of index values corresponding to a plurality of points in time during the operation of the robot 8 according to the operation program. By obtaining the change in the index value over time, the point in time when the index value is low can be identified as the point in time when the operation failed. Accordingly, the operation of the robot 8 and the positional relationship with the peripheral objects such as the workpiece at the point in time when the operation failed can be displayed on the simulation screen 200, and the operator can visually confirm the simulation screen 200 to more intuitively grasp the cause of the failure.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A robot control device for controlling a robot provided with a sensor, comprising:
a storage unit configured to store a parameter for setting an operation of the robot in association with an index value representing an operation state of the robot that operates in accordance with the parameter;
a search unit configured to search for the parameter based on the index value; and
a display unit configured to display the searched parameter.

2. The robot control device according to claim 1, wherein the parameter is stored in the storage unit in association with a cycle time of the robot, an output value of a sensor mounted on the robot or a value derived therefrom, presence or absence of an operation abnormality, and a degree of success or failure of the operation, along with the index value.

3. The robot control device according to claim 2, further comprising: a calculation unit configured to calculate the index value based on the cycle time, the output value of the sensor or the value derived therefrom, a value assigned to the presence or absence of the operation abnormality, and a value assigned to the degree of success or failure of the operation.

4. The robot control device according to claim 3, wherein a degree of weighting of each of the cycle time, the output value of the sensor or the value derived therefrom, the value assigned to the presence or absence of the operation abnormality, and the value assigned to the success or failure of the operation corresponding to the index value is changed in accordance with a level of importance input by a user.

5. The robot control device according to claim 2, wherein the display unit displays the index value associated with the searched parameter, the cycle time, the output value of the sensor or the value derived therefrom, the presence or absence of the operation abnormality, and the degree of success or failure of the operation, along with the searched parameter.

6. The robot control device according to claim 2, wherein the display unit displays a moving image that reproduces an operation of the robot when the operation was unsuccessful, based on the parameter associated with a fact that the operation was unsuccessful.

7. The robot control device according to claim 2, wherein the search unit searches for the parameter associated with a fact that the operation was successful and the parameter associated with a fact that the operation was unsuccessful.

8. The robot control device according to claim 7, wherein the display unit displays the parameter associated with the fact that the operation was unsuccessful together with how to make the operation successful.

9. The robot control device according to claim 2, wherein the degree of success or failure of the operation is input in accordance with a user instruction.

10. A robot control system in which a robot control device configured to control a robot provided with a sensor and an information processing apparatus are connected via a network, wherein
the robot control device includes:
a storage unit configured to store a parameter for setting an operation of the robot in association with an index value representing an operation state of the robot that operates in accordance with the parameter;
a search unit configured to search for the parameter based on the index value; and
a display unit configured to display the searched parameter, and
the parameter and the index value stored in the storage unit are shared with the information processing apparatus.
